(19) United States
(12) Patent Application Publication
(10) Pub. No.: US 2019/0137634 A1
(43) Pub. Date: May 9, 2019

(54) REAL TIME ENVIRONMENTAL RADIATION MONITORING

(71) Applicant: Med Vassis LLC, Houston, TX (US)

(72) Inventors: John Isham, Houston, TX (US); Clint Zeringue, Houston, TX (US)

(21) Appl. No.: 16/160,945

(22) Filed: Oct. 15, 2018

Related U.S. Application Data
(60) Provisional application No. 62/573,155, filed on Oct. 16, 2017.

(51) Int. Cl. G01T 1/02; G01T 1/202; G01T 1/208; G01T 1/24; H04Q 9/00

(52) U.S. Cl. CPC G01T 1/026; G01T 1/2023; G01T 1/208; H04Q 2209/40; G01T 1/248; G01T 1/247; H04Q 9/00; G01T 1/023

(57) ABSTRACT

A wearable dosimeter providing real-time radiation measurements based on sensitive, high gain scintillator crystals and a multipixel photon counter.

### PRIOR RELATED APPLICATIONS

This application claims priority to U.S. Ser. No. 62/573,155, filed Oct. 16, 2017, and incorporated by reference in its entirety for all purposes.

### FIELD OF THE INVENTION

The present invention relates to dosimeters that are used for ascertaining radiation dosage of staff in any facility that employs radiation, but particularly in radiation oncology clinics.

### BACKGROUND OF THE INVENTION

With the recent increase in interventional radiology cases and complex electrophysiology procedures, an increase in harmful effects of long-term radiation exposure to health care professionals has been documented. Indeed, radiology personnel experience high exposure to radiation, with the greatest exposures to the eyes, wrists, and fingers. Studies have shown that on average treating physicians are exposed to 19.84±12.45 mSv/yr and nurses are exposed to 4.73±0.72 mSv/yr dose equivalent. Long-term exposure to ionizing radiation places these medical practitioners at risk of the development of lasting health concerns such as genetic damage, bone weakness, cataracts, and secondary tumors.

To track this increased exposure, physicians and medical staff are required to wear badges that detect the radiation dose they receive over time. The film badge dosimeter—or film badge—is a personal dosimeter used for monitoring cumulative radiation exposure to ionizing radiation. The badge consists of two parts: photographic film, and a holder that clips to the user. The film emulsion is essentially black and white photographic film with varying grain size to affect its sensitivity to incident radiation. Some film dosimeters have two emulsions, one for low-dose and the other for high-dose measurements. These two emulsions can be on separate film substrates or on either side of a single substrate.

The badge is typically worn on the outside of clothing, around the chest or torso to represent dose to the “whole body”. This location monitors exposure of most vital organs and represents the bulk of body mass. Additional dosimeters can be worn to assess dose to extremities or in radiation fields that vary considerably depending on orientation of the body to the source.

After some period of use, e.g., weekly, monthly, or twice yearly, the badges are collected for processing and the user provided with a new badge. The film from the used badges is removed from its light-proof packet and developed to measure exposure. The film badge can thus be used to measure and record radiation exposure due to gamma rays, X-rays, and beta particles.

However, this delayed reading of how much radiation dose is delivered to health care professionals causes significant problems for health care systems. To ensure the safety of radiation medical providers, the focus of environmental radiation monitoring must be shifted towards accurate real-time measurements.

Though film dosimeters are still in use worldwide there has been a trend towards using other dosimeter materials that are less “energy dependent” and can more accurately assess radiation dose from a variety of radiation fields with higher accuracy.

Current occupational radiation monitoring badges incorporate either a thermoluminescent diode (TLD) or an optically stimulated diode (OSLD). As radiation interacts with the crystal inside the TLD or OSLD badge, it causes electrons in the crystal's atoms to jump to higher energy states where they remain trapped due to impurities in the crystal. In the case of TLDs, heating the crystal causes the electrons to drop back to their ground state, releasing visible light. In an OSLD, exposing the crystal to optical stimulation e.g., green light, causes the electrons to drop back to their ground state, releasing visible light.

Both TLDs and OSLDs measure ionizing radiation exposure by measuring the intensity of visible light emitted from the crystal during the readout process. The read-out process may take place on-site at periodic intervals determined by the clinic, or sent to a facility for processing. Due to the periodic nature of this process, physicians and medical personnel are at risk of being exposed to harmful amounts of radiation without their knowledge.

Special characteristics of both TLDs and OSLDs such as: sensitivity changes and dose linearity changes over accumulating dose, energy dependence, angular dependence, temperature dependence, fading, and transient signal dependence, also need to be considered and controlled to make precise measurements. Nonlinear sensitivity responses are observed after accumulated doses of >10 Gy and >3 Gy in TLD (LiF:Mg,Ti) and OSLD (Al₂O₃:C) respectively. Large energy dependencies are observed in the diagnostic x-ray energy range from 50 kV −250 kV in both TLD and OSLD dosimeters. Non-trivial angular responses (3-4%) are observed in 6 MV photon beams, and as large as 70% in diagnostic mammography in OLSD.

Temperature dependencies are also observed in ˜0.3%/° C. in OSLD, and a wait time in the dark of ˜8 min after irradiation is necessary to avoid transient light signals from interfering with the readout accuracy. In addition, measurements changed by as much as 2% over the course of the first 10 days of repeat measurements in OSLD due to fading.

Due to the above dependencies, knowledge of factors such as energy, total accumulated dose, angle, and temperature must be carefully tracked throughout the lifecycle to ensure accurate dose readings for TLD and OSLD badge technology. Often these devices are passive and do not include the necessary support infrastructure to correct for these dependencies, leading to inaccurate dose readings and occupational health risk to medical staff In addition, the reader systems for OSLD and TLD must be carefully maintained and calibrated to ensure accurate readings.

Some real-time radiation monitoring systems are described in the literature. U.S. Pat. No. 7,126,121, for example, describes a real-time video radiation exposure monitoring system comprising a Geiger-Müeller meter and a video camera linked to a computer programmed to display video images from the camera simultaneously with data from the Geiger-Müller meter. A radio modem provides wireless data communications between the Geiger-Mëller and the computer. One aspect of the invention is a retrofit of a conventional Geiger-Mueller meter to include a microcontroller with internal A/D converter enabling the meter to output instantaneous measurements in RS-232 serial format.

However, Geiger counter based systems suffer from all of the limitations of Geiger counters—namely limitations in measuring high radiation rates and the energy of incident radiation. Thus, they cannot differentiate which type of radiation is being detected. They cannot be used to determine the exact energy of the detected radiation. Finally, they have a very low efficiency.

The Electronic Personal Dosimeter (EPD) is an electronic device that allows continual monitoring and alarm warnings at preset levels. These are especially useful in high dose areas where residence time of the wearer is limited due to dose constraints. The dosimeter can be reset, usually after taking a reading for record purposes, and thereby re-used multiple times.

Modern EPD dosimeters may contain more than one type of sensor, and can therefore measure γ, β and x rays of a wide range of energies. In addition, the electronic dosimeters collect and store the reading at a fixed pattern (e.g., every 10 seconds) and keeps the data until it is downloaded from the dosimeter. This feature gives the ability to build a personal time-dependent exposure report for each worker who carries this device and to analyze, identify, and measure the exact dose, time, and duration of any exposure event he was involved in. However, the user must remember to both carry the EPD and to keep it charged, and in a world where everyone has a plethora of mobile devices, adding yet another can be dissuasive. Further, the system could be much more automated than it is, although size limitations apply since the device is carried by the user.

US20150237419 describes a radiation exposure monitoring system comprising wireless dosimeter devices made of a scintillator and silicon photodiode that are allegedly very energy efficient and that can communicate remotely with a remote host that in turn performs the dose calculations from the raw data transmitted by the wireless dosimeter devices. The system has a plurality of wireless dosimeter devices not equipped with a display screen, each comprising an integrated dosimeter, a control unit being in turn connected to a wireless transceiver for the transmission of data representative of the radiation detected by each dosimeter; at least one remote host comprising a wireless transceiver suitable for communicating with at least some of the transceivers of the dosimeter devices and with at least one remote host for tracking the wireless dosimeter. However, like the EPD, this system can be limited if ambient electromagnetic radiation interferes with the communications. Further, this application only described bismuth germanate (Bi₄Ge₃O₁₂), cadmium tungstate (CdWO₄), and cesium iodide scintillators, which have very limited linear ranges of detection and thus complicates accurate measurements.

Thus, what is needed in the art are real-time radiation monitoring systems that are robust, cost effective, and can provide early warning of excess radiation exposure, and are suitable for use with radiation sources of a variety of energy levels. The ideal device would display daily and cumulative dosage information in real time for the user, as well as reporting this information to a central database.

### SUMMARY OF THE DISCLOSURE

The invented dosimeter and dosimeter system has on-board calculation and display of daily dosage, as well as cumulative dosage, and thus offers real-time tracking of dose information for radiation oncologists. Generally speaking, we have used very fast, high performance scintillation crystals optically coupled to a multi-pixel photon counter, which has on-board temperature and dark matter compensation, thus providing accurate and real time dosage information. This real-time information can be displayed to the user on a small LED or LCD display and can be wirelessly transmitted to a remote system for keeping track of every employee's exposure.

Scintillator assemblies typically include one or more reflective coatings or layers to optimize light collection. A reflective coating can be applied atop the scintillator crystal directly or after deposition of one or more other coatings, such as a parylene coating. For example, reflective layer of aluminum can be added to the top surface of the scintillator crystal. As another option, the housing interior could be reflective, or an additional layer of reflective material could be placed over the scintillator crystal. The reflective or mirror layer covers all sides of the crystal, except the surface in contact with the MPPC, and thus vapor deposition of a reflective metal coating on three sides may be preferred.

The reflectively coated crystal can be adhered to a silicon photomultiplier using an optically transparent epoxy, such as Epoxy Technology EPO-TEK® 302-3M Optically Transparent Epoxy. United Adhesives also offers suitable epoxies. Clear gels could also be used. Alternatively, it may be possible to omit the joining layer if the layers are held in tight juxtaposition using an exterior holding system, such as a clamp, tape, frame, or housing.

Preferably the silicon photomultiplier is an “MPPC” or “multi-pixel photon counter”. The MPPC is a photon-counting device using multiple APD (avalanche photodiode) pixels operating in Geiger mode. Although the MPPC is essentially an opto-semiconductor device, it has excellent photon-counting capability and can be used in various applications for detecting extremely weak light at the photon counting level.

The MPPC operates on low voltage and features high gain, high photon detection efficiency, high-speed response, excellent time resolution, and wide spectral response range. It achieves the performance that is required in photon-counting at a high level. The MPPC is also immune to magnetic fields, highly resistant to mechanical shocks and the like, which are advantages unique to solid-state devices. They are also available in arrays, to cover larger scintillator crystals or arrays of scintillator crystals. These devices are available e.g., from Hamamatsu.

The printed circuit board will typically contain a temperature sensor, signal amplifier, analog to digital converter, a microprocessor and memory, a battery or other power source, and wireless communication capability, such as Bluetooth or Beacon.

The entirety of the detector assembly is contained in a housing, as described, which is light-tight and has a display and a button or other means for activating the display. Preferably, the display is an LED or LCD display, activated by, e.g., a membrane button. A second button can be provided to initiate wireless communications, or the first button can be used if, e.g., depressed for a sufficient length of time, or the system can allow passive activation when the wearer passes near the stand-along device. A data port allows each device to be calibrated for responsiveness to radiation, and the microprocessor loaded with a conversion factor needed to convert voltage data to dosage data. The data port can also be used for recharging an on board rechargeable battery. Alternatively, data can be pushed to the remote device wirelessly.

In one preferred embodiment, the device is light-tight and is charged inductively via an inductive charge plate, and all communications are wireless, thus facilitating the design of a light-tight compact housing.

As used herein, “real-time” means measurements become available to the wearer in less than one minute (typically in a second or less).

As used herein, measuring “dosage” means measuring the amount of radiation that a person is exposed to. This application is quite different from most military applications, where personnel want to know if there is radiation, and if there is, what kind of radiation. In a clinical environment, we do not need radio-isotope identification capabilities, since a given instrument always emits the same kind of radiation. Instead, we need to know the daily and cumulative dose that personnel have been exposed to. Crystal scintillators and MPPC have been developed for radio-isotope identification, but the requirements for that application are quite different.

As used herein, “light-tight” means the device excludes light, such that the scintillation detection is not detectably compromised by light from outside of the device. The outer housing can be made light-tight, or an interior housing or coating around the detector sandwich can be made light-tight, or both.

As used herein, “on-board” means that the dosimeter itself provides for various functions such as display, compensation, and calculation, and a separate or remote processor is not needed. Having on-board systems allow the wearer of the dosimeter to check at any time his or her current dose information.

As used herein, a silicon photomultiplier or “SiPM” is a solid-state single-photon-sensitive device built from an avalanche photodiode (APD) array on common silicon substrate. The idea behind this device is the detection of single-photon events in sequentially connected Si APDs. The dimension of each single APD can vary from 20 to 100 micrometers, and their density can be up to 1000 per square millimeter. Every APD in SiPM operates in Geiger mode and is coupled with the others by a polysilicon quenching resistor. Although the device works in digital/switching mode, the SiPM is an analog device because all the microcells are read in parallel, making it possible to generate signals within a dynamic range from a single photon to 1000 photons for a device with just a square-millimeter area. The supply voltage (Vb) depends on APD technology used and typically varies between 20 V and 100 V, thus being from 15 to 75 times lower than the voltage required for a traditional photomultiplier tubes (PMTs) operation.

As used herein an MPPC or multipixel photon counter is also known as a type of SiPM. An MPPC consists of many (100 to >1000) small avalanche photodiodes (APDs) in an area of typically 1 mm². Each APD micropixel independently works in limited Geiger mode with an applied voltage a few volts above the breakdown voltage (Vbd). When a photo-electron is produced, it induces a Geiger avalanche. The avalanche is passively quenched by a resistor integral to each pixel. The output charge Q from a single pixel is independent of the number of produced photoelectrons within the pixel, and can be written as:

Q=C(V−Vbd),

where V is the applied voltage and C is the capacitance of the pixel. Combining the output from all the pixels, the total charge from an MPPC is quantized to multiples of Q and proportional to the number of pixels that underwent Geiger discharge (“fired”). The number of fired pixels is proportional to the number of injected photons if the number of photons is small compared to the total number of pixels. Thus, the MPPC has an excellent photon counting capability.

For the MPPC, the operation voltage V is a few volts above the breakdown voltage and well below 100 V. The pixel capacitance C is on the order of 10-100 fF, giving a gain of 10⁵-10⁶. These features enable us to read out the signal from the MPPC with simple electronics. In addition, because the thickness of the amplification region is a few μm, it is insensitive to an applied magnetic field and the response is fast.

However, one of the weak points of the MPPC is the limited number of pixels, resulting in the nonlinear response of output signals. Each APD pixel has a “dead time” (typically ˜a few 10 s of nsec) once the Geiger discharge has triggered, namely, where multiple photons entering a single pixel cannot be counted within the dead time. Moreover, thermal electrons also trigger Geiger discharge, resulting in substantial contamination of “dark counts”, which typically amounts to 1-4 Mcps for 3×3 mm² MPPCs (25 μm type) measured at room temperature (+25° C.). Nevertheless, its compactness and high gain are relatively attractive in various fields of high energy physics.

Dark counts of MPPC can be severely problematic for all applications and hence should be suppressed as far as possible to ensure optimal detector performance. The idea of rejecting >99% of dark counts can be done by using an anti-coincidence technique where two MPPCs were stuck to a single plastic scintillator and triggers were generated when both MPPCs fired at the same time.

Where the decay rate of an emitting crystal is known, that can be accounted for by subtracting. The initial value is measured at the beginning during, e.g., calibration. Temperature differences can also be accounted using onboard temperature sensors and adjusting based on the actual temperatures.

As used herein, a “scintillator” is a material that absorbs radiation and emits light.

As used herein, “crystal scintillators” are usually crystals grown in high temperature furnaces, for example, alkali metal halides, often with a small amount of activator impurity. Inorganic crystals can be cut to small sizes and arranged in an array configuration so as to provide position sensitivity. Such arrays are often used in medical physics or security applications to detect X-rays or y rays: high-Z, high density materials (e.g., LYSO, BGO) are typically preferred for this type of applications.

The most widely used is NaI(Tl) (sodium iodide doped with thallium). Other inorganic alkali halide crystals are: CsI(Tl), CsI(Na), CsI(pure), CsF, KI(Tl), LiI(Eu). Some non-alkali crystals include: BaF₂, CaF₂(Eu), ZnS(Ag), CaWO₄, CdWO₄, YAG(Ce) (Y₃Al₅O₁₂(Ce)), GSO—Gadolinium oxyorthosilicate, LSO—lutetium oxyorthosilicate (Lu₂SiO₅), and LYSO (Lu₁₋ₓYₓSi₂O₅). Tables 1-4 list several crystal scintillators and their properties, and many more are known.

Newly developed products include LaCl₃(Ce), lanthanum chloride doped with cerium, as well as a cerium-doped lanthanum bromide, LaBr₃(Ce). They are both very hygroscopic, but offer excellent light output and energy resolution (63 photons/keV γ for LaBr₃(Ce) versus 38 photons/keV γ for NaI(Tl)), a fast response (16 ns for LaBr₃(Ce) versus 230 ns for NaI(Tl)), excellent linearity, and a very stable light output over a wide range of temperatures. In addition LaBr₃(Ce) offers a higher stopping power for γ rays (density of 5.08 g/cm3 versus 3.67 g/cm3 for NaI(Tl)).

LYSO (Lu_{1.8}Y_{0.2}SiO₅(Ce)) has an even higher density (7.1 g/cm³, comparable to BGO—bismuth germanate), is non-hygroscopic, and has a higher light output than BGO (32 photons/keV γ), in addition to being rather fast (41 ns decay time versus 300 ns for BGO).

LYSO(Ce) is a Cerium doped lutetium-based scintillation crystal that offers high density and a short decay time. It has an improved light output and energy resolution compared to BGO (Bi₄Ge₃O₁₂), which has a similar density. Applications that require higher throughput, better timing and better energy resolution will benefit from using LYSO material. Saint-Gobain has recently introduced an enhanced version of LYSO which offers 17% more light yield and up to 16% better energy resolution than standard LYSO.

One preferred inorganic scintillating material is inorganic scintillating material consisting of La₁₋ₓCeₓBr₃. Saint Gobain (PA) offers commercial scintillation crystal with several properties advantageous for our use, including BrilLanCe 350, which is LaCl3(10%Ce) and BrilLanCe 380, which is LaBr3(5%Ce).

BrilLanCe™ 380 (LaBr3(Ce), for example, is a transparent scintillator material that offers the superior energy resolution, fast emission, and excellent linearity. It has higher light output than NaI(T1) and also better energy resolution. BrilLanCe 380 crystals emit some 60% more light than NaI(T1) for energies near 1 MeV and have much faster decay times and better timing properties. The FWHM (full width at half maximum) for a 2″ diameter by 2″ long crystal has been measured at 2.6%. See U.S. Pat. Nos. 7,067,815; 7,067,816; 7,250,609; 7,233,006, incorporated by reference in its entirety for all purposes. These LaBr3(Ce) crystals are commercially available in sizes well suited for use in wearable badges include in 1×1 inch and 2×2 inch forms.

A disadvantage of some inorganic crystals is their hygroscopicity, a property which requires them to be housed in an air-tight enclosure to protect them from moisture. CsI(T1) and BaF₂ are only slightly hygroscopic and do not usually need protection. CsF, NaI(T1), LaCl₃(Ce), LaBr₃(Ce) are hygroscopic, while BGO, CaF₂(Eu), LYSO, and YAG(Ce) are not. Because of this, sandwiches containing these crystals are typically sealed inside a hermetically sealed housing or coating. Although doable, these design considerations contribute to both cost and to size. Therefore, in some embodiments, it is preferred to use non-hygroscopic crystals.

Zecotek's Lutetium Fine Silicate or “LFS” scintillation crystals also have good light yields (100%-NaI scale) and ultra-fast decay constant (33-36 ns), covering a wide range of emission wavelengths, with a max at 425 nm. LFS is the commercial name of the set of Ce-doped silicate scintillation crystal comprising of lutetium and crystallized in the monoclinic system, spatial group C2/c, Z=4. The composition is specified in a patent as CeₓLi_{q+p}Lu_{9.33-x-p-z□0.67}A_{z}Si₆O₂₆₋ₚ, where A is at least one element selected from the group consisting of Ca, Gd, Sc, Y, La, Eu and Tb and the x, p and q values lie within certain specific ranges. See e.g., U.S. Pat. No. 7,132,060, incorporated by reference in its entirety for all purposes. Importantly, these crystals are not hygroscopic, meaning that packaging them inside a housing is much simpler and more cost effective than a hygroscopic crystal, which must be protected from humidity. Thus, although light yields are somewhat reduced from lanthanum based crystals, the assembly, size, and cost are superior.

In preferred embodiments, the crystal is shaped to provide maximum collection of photons, and thus hemispheres or cylinders are preferred over rectangular box shapes.

The high-performance scintillator crystal is optically coupled to a silicon photomultiplier, which in turn is operably coupled to a printed circuit board for converting scintillation light generated voltage to dosage data. The entire device is housed inside a light-tight (and possibly air-tight) housing, which has a display for displaying dosage, as well as wireless communication ability to communicate dosage information to stand-alone devices at either defined intervals or when the wearer passes close enough to passively initiate a download.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, and “include” (and their variants) are open-ended linking verbs and allow the addition of other elements when used in a claim. The phrase “consisting of” excludes additional elements, and the term “consisting essentially of” excludes material elements, but allows the inclusion of nonmaterial elements, such as labels, instructions for use, and the like.

### BRIEF DESCRIPTION OF DRAWINGS

FIG. 1 shows a perspective view of one embodiment of the device.

FIG. 2A shows a cross section of the detector sandwich of FIG. 1.

FIG. 2B shows a device like that of FIG. 2A, but with a hemispherical crystal.

FIG. 2C shows a device like that of FIG. 2A, but with a cylindrical crystal.

FIG. 3 is a side view of the device of FIG. 1.

FIG. 4 is a perspective view of another embodiment of the complete device.

FIG. 5 is a block diagram of an MPPC module.

FIG. 6A-6E is the printed circuit board and layout of the MPPC module.

### DETAILED DESCRIPTION OF THE INVENTION

The following descriptions and figures are exemplary only and should not be used to unduly limit the scope of the invention.

According to a study conducted by the Department of Radiological Technology in the School of Health Sciences at Tohoku University, the annual mean dose equivalent exposure during electrophysiology and interventional radiology procedures was 19.84±12.45 and 4.73±0.72 mSv/y to the neck for physicians and nurses respectively. Each of the 18 physicians in the study performed and average of 293.3±144.8 coronary angiography and 73.7±38.9 percutaneous coronary intervention (PCI) procedures annually. On average, each of the 7 nurses was involved in 754.3±352.3 coronary angiography and 189.4±PCI procedures annually. From this data, we estimate that the average exposure (per combined coronary angiograph and PCI procedure) to physicians and nurses is 0.054 mSv [0.0054 cGy] and 0.005 mSv [0.0005 cGy] respectively.

In order to effectively monitor these dose levels, the detector must have high sensitivity. Ideally, the minimum detectable dose of the measurement system would be 10-100 times lower than the dose received during treatments to accurately monitor and store the accumulated dose during the procedures. This imposes a lower limit on the noise-equivalent dose (NED) of the dosimetry badge of 0.00001-0.0001 cGy [0.01 mrem-0.1 mrem]. Most commercially available badge dosimeters lack this sensitivity. For example, Landauer's Luxel® OSL dosimetry badge has a lower limit of 1 mrem±2 mrem.

Our wearable real-time occupational radiation monitoring detection system thus consists of a scintillation crystal coupled to a suitable photometer and meets the following technical specifications:
Detection capability of at least 5 keV-5 MeV photons
Continuous Dose Measurement Range of at least 0.01 mrem/s-1 rem/s
Operating Temperature of at least 25±10 C (though MPCCs function at −40 to 85° C.),
Accuracy of at least±5%.

TABLES 1-5 show scintillation crystal properties.

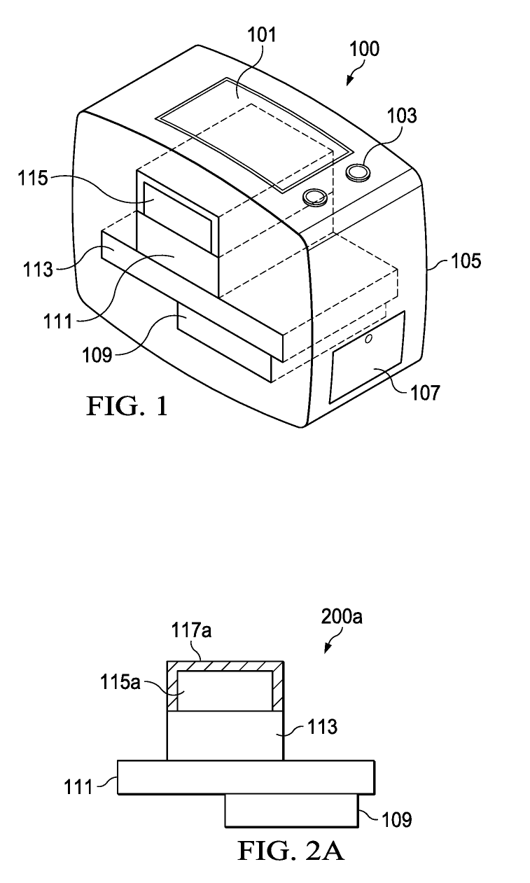

FIG. 1 is a perspective view of one embodiment of the device. In the perspective view of the complete device 100, the housing exterior surface 105 shows a display 101 and on/off switches 103. Also seen is access hatch 107 for reaching the power source, typically a battery. The detector sandwich can also be seen, as one wall is omitted for visibility. The access hatch could be a USB or other port, and thus serve for both recharging an interior battery as well as for data communications. Alternatively, it can be merely a door to reach the battery.

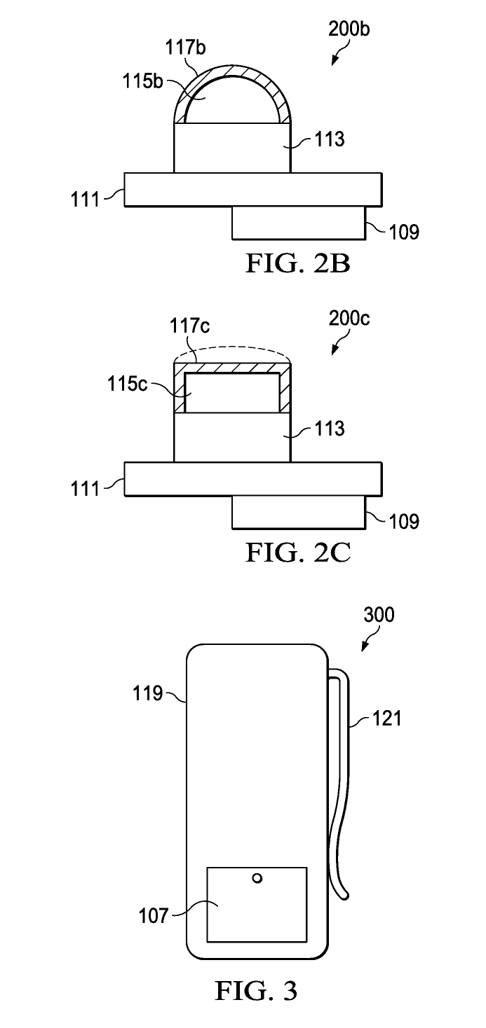

The detector sandwich is seen in greater detail in the cross-sectional view of FIG. 2A-2C, where we see the reflective coating 117a covering the scintillator crystal 115a on all surfaces except the one that is optically coupled to the SiPM 113 below. This is then mounted on a printed circuit board 111, which hosts the electronics needed to convert the current generated by photons impacting the SiPM to voltage and then to dosage information. A power source 109 powers the various electronics, including SiPM, current amplifier if used, digital to analog converter, microprocessor and memory, as well as data transmission components. FIG. 2B shows a hemispherical crystal scintillator 115b and coating 117b. FIG. 2C shows a cylinder 115c and coating 117c.

A means for clipping the device to a shirt or pocket can be seen in the side view 300 of FIG. 3, where the housing 119 is shown with clip 121, and access hatch 107. Of course, a pin, alligator clip, spring clip, magnet, and any other attachment means could be used.

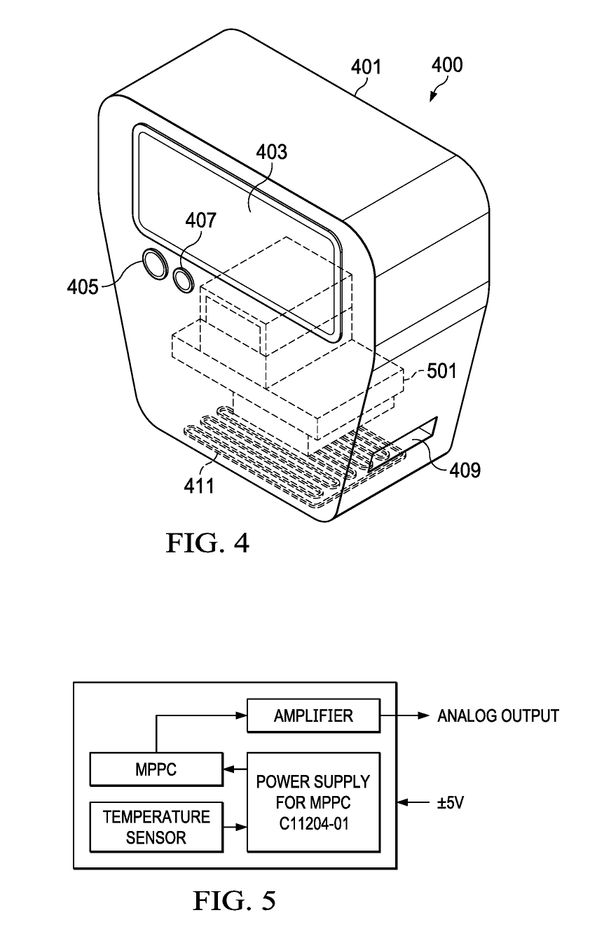

FIG. 4 is a perspective view of another embodiment of a complete device 400. The housing 401 exterior surface shows a display 403, display switch 405 and data transmission switch 407. Also seen is data port 409, used for calibration purposes, and inductive charging plate 411 in dotted outline on the base. In dotted line inside the housing, the detector sandwich 501 can be seen. The attaching means are not seen behind the device in this view.

In our prototypes, we used a MPPC module from Hamatsu (C13367-3050EA), with a separate 6×6×5 mm LFS crystal, also from Hamatsu. During prototype development, the crystal was optically coupled with optical glue or KY jelly, but for manufacturing, the crystal can be purchased already coupled to the MPPC.

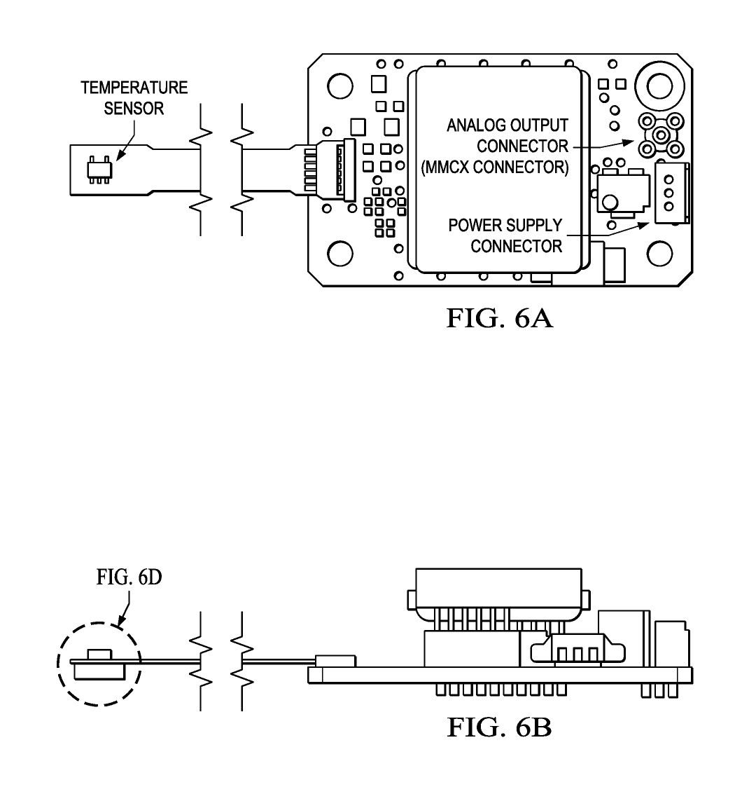

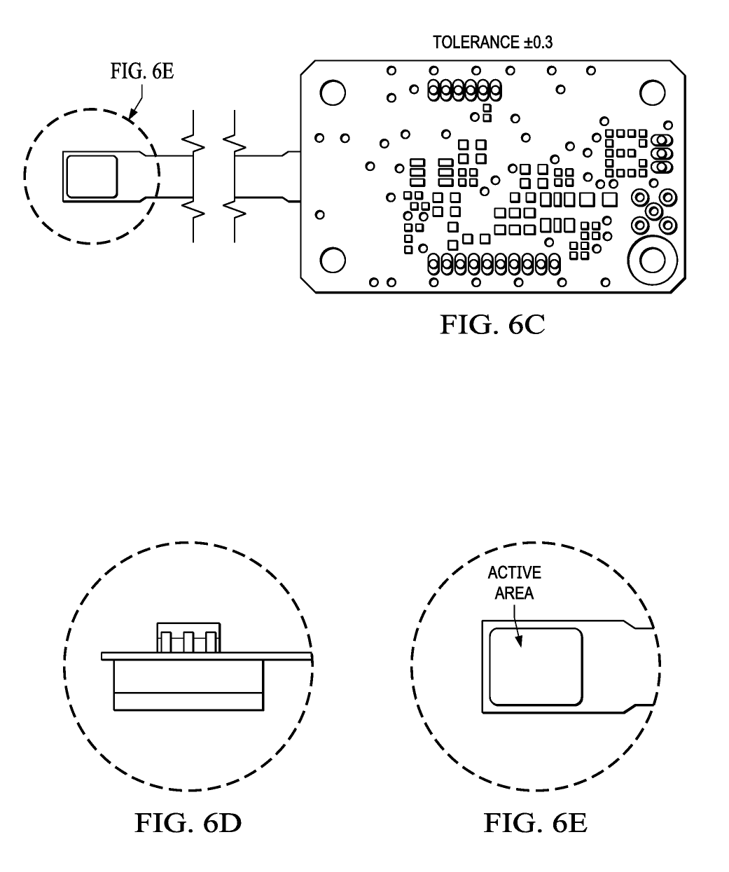

The MPPC module comes preassembled with an MPPC (3600 pixels, 3×3 mm) with flexible cable, a signal amplifier circuit, a high voltage power supply circuit, and a temperature compensation circuit. The photosensitive area is 3×3 mm and the output is analog. The module will operate if connected to an external power supply (+/−5 V). The MMCX coaxial cable for analog output is added at the customer site. A block diagram of the module is shown in FIG. 5, and the PCB with MPPC mounted thereon (large square) is shown in FIG. 6. The performance characteristics of this module are shown in TABLE 5.

We will test and validate thermal and vibrational performance of the modules by subjecting them to various external temperature and vibration changes consistent with normal wear of the device. The modules will be packaged and hermetically sealed and irradiated using X-rays from 5-5000 keV to assess linearity over the diagnostic imaging range. We will also determine the minimum detectable dose and dose accuracy over this energy range to determine necessary changes or refinements to the modules to meet the performance specifications.

We expect to measure a linear response across the entire energy range tested, consistent with the Brilliance 380 and/or LFS technical specifications. We also expect to be able to accurately characterize the minimum detectible dose and accuracy of the dosimetry badge across the entire energy range. We expect that refinements to the electronic design and SiPM modules may be necessary based on preliminary findings after these initial studies. Given our past experience in designing PSD systems, we do not expect any major obstacles in procurement, design, or engineering of the detector modules.

We will also develop a suitable wireless transmission system capable of displaying and transmitting real-time dose data and accumulated dose data stored on the modules to a mobile application or display station.

We will develop, e.g., a Bluetooth based wireless transmission and receiver system. The system will display dose measurements on the badge and deliver encrypted data over Bluetooth channel to a display station and/or mobile application. The dose data will be accessible to the user and medical staff, but remain HIPPA compliant and protected using biometric and/or login credentials.

A partner will design, develop, and implement the necessary software/hardware and transmission protocols to incorporate the display, transmission, storage, and retrieval of the dose data from the dosimetry badge module to the mobile display station. We will then test the wireless transmission and retrieval of data during and after irradiation of the dosimetry modules.

Beacon is a protocol developed by Apple and introduced in 2013. Various vendors have since made iBeacon-compatible hardware transmitters—typically called beacons—a class of Bluetooth low energy (BLE) devices that broadcast their identifier to nearby portable electronic devices. The technology enables smartphones, tablets and other devices to perform actions when in close proximity to an iBeacon.

iBeacon is based on Bluetooth low energy proximity sensing by transmitting a universally unique identifier picked up by a compatible app or operating system. The identifier and several bytes sent with it can be used to determine the device's physical location, track customers, or trigger a location-based action on the device such as a check-in on social media or a push notification. In this instance, the technology will be used to identify a user, initiate a wireless connection, and automatically upload identity and dose information to a receiver or base unit.

Other beacon technologies exist, such as Google's Eddyston beacon, and the like, and any new wireless communication protocols can be used.

Various protocols are available for uploading data on proximity. For example, U.S. Pat. No. 9,560,143 (incorporated by reference in its entirety for all purposes) describes a system and method for automatic session data transfer between computing devices based on zone transition detections. A wearable computing device has 1) a data processor; 2) a memory coupled with the data processor for persistent user data storage; 3) a wireless transceiver in data communication with the data processor; 4) a unique user identifier storable in the memory; and 5) logic, at least a portion of which is partially implemented in hardware, configured to wirelessly receive an upload of user session data from a first computing device via the wireless transceiver, to store the user session data in the memory, to authenticate a second computing device using the unique user identifier, and to wirelessly download the user session data from the memory to the authenticated second computing device via the wireless transceiver, the user session data including data for recreating a computing session from the first computing device on the second computing device.

Similar technologies are described e.g., in US20050221829, US20060026288 and US20140073300, each incorporated by reference in its entirety for all purposes. US20130102250, for example, describes a system for transferring active communication sessions between apparatuses. In one implementation, a first apparatus may receive information including at least identity information corresponding to a second apparatus via close-proximity wireless communication. The receipt of the identity information then triggers the first apparatus to determine whether it is already in a communication session. If it is determined that the first apparatus is in a communication session, it may be further determined, based on the identity information, whether automatic transfer of the communication session is permitted. If the first apparatus determines that the automatic transfer is permitted, the first apparatus may then initiate a transfer of the communication session to the second apparatus.

We expect to successfully design and implement a wireless transmission system capable of displaying, sending, retrieving, and storing dose information unique to each badge and user. Bluetooth technology is a standard used throughout the medical device and consumer markets and parts are readily available. Our partner also has specific expertise in Bluetooth technology, security, usability, and engineering of medical devices as well as ISO and IEC certifications in Risk (ISO 14971), Software (IEC 62304), Quality (ISO 13485), and Electrical (IEC 60601).

The wireless communication interface may include a short range (e.g., WiFi®, Bluetooth®, and other wireless local area network (WLAN) protocols) and/or a long range (e.g., wireless wide area network (WWAN), mobile cellular, etc.) wireless communication interface(s). For example, the interface may allow for communications to be transmitted and received to/from the wearable radiation detector and other electronic devices. The other electronic devices may be local or remotely located devices such as sensors, computers, servers, monitors, controllers, etc. The other electronic devices may set the wearable device's radiation detector thresholds or other parameters, and may have access to the radiation levels detected by the radiation detectors. For example, the wireless communication interface may transmit the radiation information (e.g., radiation type, radiation levels, warnings, etc.) to a remote server where such data is monitored by other personnel and/or recorded. The system could also push communications to the user, e.g., a user's smart phone may receive monthly dose information.

The following citations are incorporated by reference herein in their entireties for all purposes:

U.S. Pat. No. 7,126,121 Real-time video radiation exposure monitoring system

US20150237419 Radiation exposure monitoring device and system

van Loef et al., Scintillation properties of LaBr₃:Ce³⁺ crystals: fast, efficient and high-energy-resolution scintillators”, Nucl. Instr. Meth. Physics Res. A 486:254-258 (2002).

U.S. Pat. Nos. 7,067,815; 7,067,816; 7,250,609; 7,233,006.

T. Miura, T., et al., Development of a scintillation detector using a MPPC as an alternative to an APD, THE 9th INTERNATIONAL CONFERENCE ON POSITION SENSITIVE DETECTORS, 12-16 SEPTEMBER 2011, available online at iopscience.iop. org/article/10.1088/1748-0221/7/02/CO2036/pdf.

Meskal, J. Z., Detector and detector systems for particle and nuclear physics (2015), online at oeaw. ac. at/fileadmin/sub sites/etc/Institute/SMI/PDF/Detectors_WS2014-15_A2.pdf

Boltruczyka, G., et al., Development of MPPC-based detectors for high count rate DT campaigns at JET, Proceedings of 29th Symposium on Fusion Technology (SOFT 2016), available online at euro-fusionscipub.org/wp-content/uploads/WPJET4CP16_15430_submitted. pdf

Ginzburg, D., et al., Personal radiation detector at a high technology readiness level that satisfies DARPA's SN-13-47 and SIGMA program requirements, Nuclear Instruments and Methods in Physics Research A784: 438-447 (2015), available online at infona.pl/resource/bwmetal.element.elsevier-6ee3ce2c-9de9-3b0b-8e65-744e83c2c565.

US20050221829 System and method for proximity motion detection in a wireless network

US20060026288 Method and apparatus for integrating wearable devices within a SIP infrastructure

US20130102250 Close-proximity wireless communication transfer

US20140073300 Managing Telecommunication Services using Proximity-based Technologies

TABLE 1

| | | | Light | | | | |
|---|---|---|---|---|---|---|---|
| | | | yield after | | | | |
| | Light yield | ER for | exposure | ER after | DT | | Time of exposure |
| Compound | (photon/MeV) | Cs137 | (percent) | exposure | (ns) | Hygroscopicity | Srf changes |
| 1 | 2 | 3 | 4 | 5 | 6 | 7 | 8 |

La₍₁₋ₘ₋ₙ₎HfₙCeₘBr₍₃₊ₙ₎

| | | | | | | | |
|---|---|---|---|---|---|---|---|
| La_{0.95}Ce_{0.05}Br₃ | 63000 | 2.8 | 40 | 6.3 | 18 | hygrosc. | T = 2 h. |
| | | | | | | | Srf clouded, Srf |
| | | | | | | | structure changed |
| La_{0.948}Hf_{0.002}Ce_{0.05}Br_{3.002} | 62000 | 2.8 | 96 | 2.9 | 18 | nonhygr. | T = 4 h. |
| | | | | | | | Srf not changed |
| La_{0.986}Hf_{0.004}Ce_{0.01}Br_{3.004} | 60000 | 2.9 | 96 | 3.0 | 20 | nonhygr. | T = 4 h. |
| | | | | | | | Srf not changed |
| La_{0.935}Hf_{0.015}Ce_{0.05}Br_{3.015} | 60000 | 3.0 | 97 | 3.1 | 21 | nonhygr. | T = 4 h. Srf not |
| | | | | | | | changed |
| | | | | | | | Crystal colored |

La₍₁₋ₘ₋ₙ₎HfₙCeₘCl₍₃₊ₙ₎

| | | | | | | | |
|---|---|---|---|---|---|---|---|
| La_{0.90}Ce_{0.10}Cl₃ | 45000 | 3.8 | 50 | 7 | 20 | hygrosc. | T = 2 h. |
| | | | | | | | Srf clouded, Srf |
| | | | | | | | structure changed |
| La_{0.919}Hf_{0.001}Ce_{0.08}Cl_{3.001} | 44000 | 4.2 | 90 | 4.6 | 21 | slightly | T = 4 h. Srf clouded |
| | | | | | | hygrosc. | slightly, Srf |
| | | | | | | | structure not |
| | | | | | | | changed |
| La_{0.916}Hf_{0.004}Ce_{0.08}Cl_{3.004} | 43000 | 4.3 | 94 | 4.4 | 22 | nonhygr. | T = 4 h. |
| | | | | | | | Srf not changed |
| La_{0.905}Hf_{0.015}Ce_{0.08}Cl_{3.015} | 41000 | 4.4 | 96 | 4.5 | 22 | nonhygr. | T = 4 h. |
| | | | | | | | Srf not changed, |
| | | | | | | | crystal colored |

La₍₁₋ₘ₋ₙ₎HfₙCeₘI₍₃₊ₙ₎

| | | | | | | | |
|---|---|---|---|---|---|---|---|
| La_{0.95}Ce_{0.05}I₃ | 31000 | 5.3 | 48 | 7.2 | 24 | hygrosc. | T = 2 h. |
| | | | | | | AA | Srf clouded, Srf |
| | | | | | | | structure changed |
| La_{0.945}Hf_{0.005}Ce_{0.05}I_{3.005} | 30000 | 5.4 | 95 | 5.5 | 24 | nonhygr. | T = 4 h. |
| | | | | | | | Srf not changed |

Gd₍₁₋ₘ₋ₙ₎HfₙCeₘBr₍₃₊ₙ₎

| | | | | | | | |
|---|---|---|---|---|---|---|---|
| Gd_{0.979}Hf_{0.001}Ce_{0.02}Br_{3.001} | 35000 | 9.4 | 87 | 10 | 20 | slightly | T = 4 h. Srf clouded |
| | | | | | | hygrosc. | slightly, Srf |
| | | | | | | | structure not |
| | | | | | | | changed |
| Gd_{0.948}Hf_{0.002}Ce_{0.05}Br_{3.002} | 38000 | 9.1 | 94 | 9.3 | 19 | nonhygr. | T = 4 h. |
| | | | | | | | Srf not changed |

Gd₍₁₋ₘ₋ₙ₎HfₙCeₘCl₍₃₊ₙ₎

| | | | | | | | |
|---|---|---|---|---|---|---|---|
| Gd_{0.948}Hf_{0.002}Ce_{0.05}Cl_{3.002} | 29000 | 12 | 95 | 12.1 | 22 | nonhygr. | T = 4 h. |
| | | | | | | | Srf not changed |
| Gd_{0.988}Hf_{0.002}Ce_{0.01}Cl_{3.002} | 24000 | 12.8 | 96 | 13 | 20 | nonhygr. | T = 4 h. |
| | | | | | | | Srf not changed |
| Lu₍₁₋ₘ₋ₙ₎HfₙCeₘBr₍₃₊ₙ₎ | | | | | | | |
| Lu_{0.988}Hf_{0.002}Ce_{0.01}Br_{3.002} | 20000 | 7.5 | 93 | 7.7 | 32 | nonhygr. | T = 4 h. |
| | | | | | | | Srf not changed |
| Lu_{0.948}Hf_{0.002}Ce_{0.05}Br_{3.002} | 27000 | 6.4 | 94 | 6.6 | 30 | nonhygr. | T = 4 h. |
| | | | | | | | Srf not changed |
| Lu₍₁₋ₘ₋ₙ₎HfₙCeₘI₍₃₊ₙ₎ | | | | | | | |
| Lu_{0.988}Hf_{0.002}Ce_{0.01}I_{3.002} | 50000 | 4.2 | 56 | 7.3 | 27 | hygrosc. | T = 3 h. Srf clouded, |
| | | | | | | AA | Srf structure |
| | | | | | | | changed |
| Lu_{0.986}Hf_{0.004}Ce_{0.01}I_{3.004} | 45000 | 4.4 | 96 | 4.5 | 30 | nonhygr. | T = 4 h. |
| | | | | | | | Srf not changed |

Y₍₁₋ₘ₋ₙ₎HfₙCeₘI₍₃₊ₙ₎

| | | | | | | | |
|---|---|---|---|---|---|---|---|
| Y_{0.948}Hf_{0.002}Ce_{0.05}I_{3.002} | 42000 | 4.5 | 95 | 4.6 | 35 | nonhygr. | T = 4 h. |
| | | | | | | | Srf not changed |
| Y_{0.946}Hf_{0.004}Ce_{0.05}I_{3.004} | 43000 | 4.6 | 96 | 4.7 | 36 | nonhygr. | T = 4 h. |
| | | | | | | | Srf not changed |

TABLE 2
Ln₍₁₋ₘ₎CeₘA₃: n•Hf⁴⁺

| | | | | Light | | | | |
|---|---|---|---|---|---|---|---|---|
| | n | | | yield after | | | | |
| Matrix | (mol | Light yield | ER for | exposure | ER after | DT | | Time of exposure |
| material | %) | (photon/MeV) | Cs137 | (percent) | exposure | (ns) | Hygroscopicity | Srf changes |
| 1 | 2 | 3 | 4 | 5 | 6 | 7 | 8 | 9 |
| La_{0.95}Ce_{0.05}Br₃ | 0 | 63000 | 2.8 | 40 | 6.3 | 18 | hygrosc. | T = 2 h. Srf clouded, |
| | | | | | | | | Srf structure |
| | | | | | | | | changed |
| La_{0.95}Ce_{0.05}Br₃ | 0.2 | 62000 | 2.8 | 96 | 2.9 | 18 | nonhygr. | T = 4 h. |
| | | | | | | | | Srf not changed |
| La_{0.99}Ce_{0.01}Br₃ | 0.4 | 60000 | 2.9 | 96 | 3.0 | 20 | nonhygr. | T = 4 h. |
| | | | | | | | | Srf not changed |
| La_{0.95}Ce_{0.05}Br₃ | 1.5 | 60000 | 3.0 | 97 | 3.1 | 21 | nonhygr. | T = 4 h. Srf not |
| | | | | | | | | changed, crystal |
| | | | | | | | | colored |
| La_{0.90}Ce_{0.10}Cl₃ | 0 | 45000 | 3.8 | 50 | 7 | 20 | hygrosc. | T = 2 h. Srf clouded, |
| | | | | | | | | Srf structure |
| | | | | | | | | changed |
| La_{0.92}Ce_{0.08}Cl₃ | 0.1 | 44000 | 4.2 | 90 | 4.6 | 21 | slightly hygrosc. | T = 4 h. Srf slightly |
| | | | | | | | | clouded, Srf |
| | | | | | | | | structure not |
| | | | | | | | | changed |
| La_{0.92}Ce_{0.08}Cl₃ | 0.4 | 43000 | 4.3 | 94 | 4.4 | 22 | nonhygr. | T = 4 h. |
| | | | | | | | | Srf not changed |
| La_{0.92}Ce_{0.08}Cl₃ | 1.5 | 41000 | 4.4 | 96 | 4.5 | 22 | nonhygr. | T = 4 h. |
| | | | | | | | | Srf not changed, |
| | | | | | | | | crystal colored |
| La_{0.95}Ce_{0.05}I₃ | 0 | 31000 | 5.3 | 48 | 7.2 | 24 | hygrosc. | T = 2 h. Srf clouded, |
| | | | | | | | AA | Srf structure |
| | | | | | | | | changed |
| La_{0.95}Ce_{0.05}I₃ | 0.5 | 30000 | 5.4 | 95 | 5.5 | 24 | nonhygr. | T = 4 h. |
| | | | | | | | | Srf not changed |
| Gd_{0.98}Ce_{0.02}Br₃ | 0.1 | 35000 | 9.4 | 87 | 10 | 20 | slightly hygrosc. | T = 4 h. Srf slightly |
| | | | | | | | | clouded, Srf |
| | | | | | | | | structure not |
| | | | | | | | | changed |
| Gd_{0.95}Ce_{0.05}Br₃ | 0.2 | 38000 | 9.1 | 94 | 9.3 | 19 | nonhygr. | T = 4 h. |
| | | | | | | | | Srf not changed |
| Gd_{0.95}Ce_{0.05}Cl₃ | 0.2 | 29000 | 12 | 95 | 12.1 | 22 | nonhygr. | T = 4 h. |
| | | | | | | | | Srf not changed |
| Gd_{0.99}Ce_{0.01}Cl₃ | 0.2 | 24000 | 12.8 | 96 | 13 | 20 | nonhygr. | T = 4 h. |
| | | | | | | | | Srf not changed |
| Lu_{0.99}Ce_{0.01}Br₃ | 0.2 | 20000 | 7.5 | 93 | 7.7 | 32 | nonhygr. | T = 4 h. |
| | | | | | | | | Srf not changed |
| Lu_{0.95}Ce_{0.05}Br₃ | 0.2 | 27000 | 6.4 | 94 | 6.6 | 30 | nonhygr. | T = 4 h. |
| | | | | | | | | Srf not changed |
| Lu_{0.99}Ce_{0.01}I₃ | 0.1 | 50000 | 4.2 | 56 | 7.3 | 27 | hygrosc. | T = 3 h. Srf clouded, |
| | | | | | | | AA | Srf structure |
| | | | | | | | | changed |
| Lu_{0.99}Ce_{0.01}I₃ | 0.4 | 45000 | 4.4 | 96 | 4.5 | 30 | nonhygr. | T = 4 h. |
| | | | | | | | | Srf not changed |
| Y_{0.95}Ce_{0.05}I₃ | 0.2 | 42000 | 4.5 | 95 | 4.6 | 35 | nonhygr. | T = 4 h. |
| | | | | | | | | Srf not changed |
| Y_{0.95}Ce_{0.05}I₃ | 0.4 | 43000 | 4.6 | 96 | 4.7 | 36 | nonhygr. | T = 4 h. |
| | | | | | | | | Srf not changed |

TABLE 3

| | | Radiation | | | |
|---|---|---|---|---|---|
| | Density | length, | PL output | Decay | Appli- |
| Material | (g/cm³) | X₀ (cm) | (Photons/MeV) | (ns) | cation |
| NaI:Tl | 3.67 | 2.59 | 38000 | 230 | General |
| | | | | | purpose |
| CsF | 4.11 | 2.23 | 2000 | 2.8 | |
| CsI:Tl⁺ | 4.53 | 1.86 | 59000 | 1050 | X-CT |
| CsI | 4.51 | 1.85 | 30* | 6, 35 | |
| Bi₄Ge₃O₁₂ | 7.13 | 1.12 | 8200 | 300 | PCT, NP, |
| | | | | | HE |
| CdWO₄ | 7.68 | 1.06 | 15000 | 5000 | X-CT |
| Gd₂SiO₅:Ce | 6.71 | 1.38 | 10000 | 60 | PET |
| Lu₂SiO₅:Ce | 7.4 | 1.14 | 30000 | 40 | PET |
| PbWO₄ | 8.2 | 0.92 | 490 | 10 | HE |

NP: Nuclear physics experiment
HE: High energy physics experiment
*Faster decay component
⁺Slight hygroscopicity

TABLE 4
LFS scintillation crystals: Industry product comparison

| | Crystal* | | | | | | | |
|---|---|---|---|---|---|---|---|---|
| Parameter | Tl:NaI | BGO | LSO | GSO | LYSO | LFS-3 | LFS-7 | LFS-8 |
| Density, g/cm³ | 3.67 | 7.13 | 7.4 | 6.71 | 7.1 | 7.35 | 7.4 | 7.4 |
| Effective at. number | 51 | 74 | 66 | 57 | 66 | 64 | 64 | 64 |
| Attenuation length, cm | 2.6 | 1.11 | 1.14 | 1.38 | 1.12 | 1.15 | 1.12 | 1.14 |
| Decay constant, ns | 230 | 300 | 40 | 30-60 | 41 | 25-33 | 30-35 | 12-25 |
| Max emission, nm | 415 | 480 | 420 | 430 | 420 | 425 | 412-416 | 422 |
| Light yield | 100 | 7-12 | 40-75 | 20 | 70-80 | 80-85 | 80-85 | 80-85 |
| (NaI:Tl = 100%) | | | | | | | | |
| Refractive index | 1.85 | 2.15 | 1.82 | 1.85 | 1.81 | 1.81 | 1.81 | 1.81 |
| Energy resolution ¹³⁷Cs, % | 8 | 12-14 | 10-14 | 9.5 | 8.0 | 8 | 8 | 7 |
| Absorbed y-ray | 10 | 10²⁻³ | 10⁸ | 10⁸⁻⁹ | 10⁸ | 10⁸ | 10⁸ | 10⁸ |
| irradiation dose, rad | (?) | (?) | (7) | (6) | (7) | (2) | (7) | (7) |
| (rad. Hardness, %/cm)^{†} | | | | | | | | |
| Hygroscopicity | strong | No | No | No | No | No | No | No |
| Hardness, Moh | 2 | 4.5 | 5.8 | 5.7 | 5.8 | 5.8 | 5.8 | 5.8 |
| Cleavage | (100) | none | none | (100) | none | none | none | none |
| Boule size, mm | Ø400 × 600 | Ø100 × 250 | Ø75 × 200 | Ø75 × 150 | Ø75 × 150 | Ø90 × 250 | Ø90 × 250 | Ø50 × 200 |

*The chemical composition of the competing crystals: BGO—Bi₄Ge₃O₁₂, LSO—Ce:Lu₂SiO₅, GSO—Ce:Gd₂SiO₅; LYSO—Ce:Lu_{1.8}Y_{0.2}SiO₅
^{†}Induced optical transmission loss after exposure to radiation is a more realistic and quantifiable measure of the radiation hardness than the absorbed radiation dose.

TABLE 5
Absolute maximum ratings

| Parameter | Symbol | Condition | Value | Unit |
|---|---|---|---|---|
| Supply voltage | Vs | | ±6 | V |
| Operating temperature | Topr | No condensation | −20 to +60 | ° C. |
| Storage temperature | Tstg | No condensation | −20 to +70 | ° C. |

Electrical and optical characteristics (Typ. Ta = 25° C., λ = λp, Vs = ±5 V,
unless otherwise noted

| Parameter | | Symbol | Condition | Min. | Typ. | Max | Unit |
|---|---|---|---|---|---|---|---|
| Spectral response range | | λ | | 320 to 900 | | | nm |
| Peak sensitivity wavelength | | λp | | 500 | | | nm |
| Photosensitive area size | | — | | 3 × 3 | | | mm |
| Pixel pitch | | — | | 50 | | | μm |
| Number of pixels | | — | | 3600 | | | — |
| Temperature stability of | | — | Ta = 25 ± 10° C. | — | — | ±5 | % |
| output voltage | | | | | | | |
| Photon detection efficiency | | — | | 0.7 | 1.0 | 1.3 | ×10⁹ V/W |
| Rise time | | | 10% to 90% | — | 9 | — | ns |
| Cutoff | High band | fc | −3 dB | 3.5 | 5 | — | MHz |

| | | | |
|---|---|---|---|
| frequency | Low band | DC | — |

| | | | | | | |
|---|---|---|---|---|---|---|
| Noise equivalent power | NEP | Dark condition | — | 1.2 | 2 | fW/Hz^{1/2} |
| Minimum detection limit | — | Dark condition | — | 2.7 | 4.5 | pW.r.m.s. |

| | | | |
|---|---|---|---|
| Maximum output voltage | — | 4.7 | V |

1. A wearable real-time radiation dosimeter, comprising:
a) a housing having an exterior surface surrounding an interior space;
b) said exterior surface having at least:
i) a display for displaying a measured radiation dosage;
ii) an on/off switch for activating said display;
iii) means for mounting said housing to an item of clothing;
c) said interior space containing therein a plurality of layers stacked in the following order:
i) a crystal scintillator optically coupled to a silicon photomultiplier (SiPM) for detecting photons, said crystal scintillator SiPM having the following characteristics:
(1) a lower limit on noise-equivalent dose (NED) of 0.01 mrem-0.1 mrem;
(2) detection capability of at least 5 keV-5 MeV photon energies;
(3) a continuous dose measurement range of at least 0.01 mrem/s-1 rem/s;
(4) an operating temperature of at least 25±10° C.; and
(5) an accuracy of at least±5%;
ii) said silicon photomultiplier (SiPM) being electrically coupled to a printed circuit board comprising:
(1) a transimpedence amplifier for amplifying an analog voltage from said SiPM operably coupled to:
(2) an analog to digital converter for converting said analog voltage to a digital voltage operably coupled to:
(3) a microprocesser for converting said digital voltage to a dosage operably coupled to:
(4) a memory for storing said dosage operably coupled to:
(5) a wireless transmitter for transmitting said dosage to a separate device; and
(6) a power source configured to power said dosimeter.

2. The dosimeter of claim 1, wherein said crystal scintillator is coated on all sides that do not optically couple to said SiPM with an inward facing reflective coating.

3. The dosimeter of claim 2, wherein said crystal scintillator is in the shape of a cylinder, having a flat side optically coupled to said SiPM.

4. The dosimeter of claim 2, wherein said crystal scintillator is in the shape of a hemisphere, having a flat side optically coupled to said SiPM.

5. The dosimeter of claim 1, wherein said crystal scintillator is a LaBr(Ce) crystal and said LaBr(Ce) crystal is hermetically sealed.

6. The dosimeter of claim 1, wherein said crystal scintillator is a Lutetium Fine Silicate (LFS) crystal scintillator.

7. The dosimeter of claim 1, wherein SiPM is a multipixel photon counter (MPPC).

8. The dosimeter of claim 1, wherein said exterior surface has an access hatch for accessing a power source or data or both.

9. The dosimeter of claim 1, wherein said power source is a battery and said exterior surface has an access hatch for accessing said battery or data or both.

10. The dosimeter of claim 1, wherein said power source is a rechargeable battery and said exterior surface has an access hatch for accessing said rechargeable battery.

11. The dosimeter of claim 1, wherein said exterior surface has an inductive charging plate and said power source is an inductively rechargeable battery.

12. The dosimeter of claim 1, wherein said exterior surface has a data port for loading one or more conversion factor(s) for converting voltage to dosage.

13. The dosimeter of claim 1, wherein said exterior surface has a data port for loading one or more conversion factor(s) for converting voltage to dosage and for powering a rechargeable power source.

14. The dosimeter of claim 1, wherein said exterior surface has an on/off switch for initiating data transmission.

15. The dosimeter of claim 1, wherein said dosimeter has means for automatically initiating data transmission in proximity to a receiver.

16. The dosimeter of claim 1, wherein a transparent epoxy layer adheres said scintillator crystal scintillator to said SiPM.

17. The dosimeter of claim 1, wherein said display is a LCD or LED display.

18. The dosimeter of claim 1, wherein components c)-i) to c)-ii) are hermetically sealed inside said housing so as to exclude moisture.

19. The dosimeter of claim 1, further comprising a unique serial number that functions as a user ID.

20. The dosimeter of claim 19, wherein said user ID comprises an iBeacon or Bluetooth communication protocol.

21. The dosimeter of claim 1, wherein said wireless transmitter is configured to receive calibration data, or wherein said device housing has a dataport for receiving calibration data.

22. The dosimeter of claim 21, wherein said scintillation crystal has a footprint of 5 mm×5 mm or less.

23. A wearable real-time radiation dosimeter, comprising:
a) a light tight housing having an exterior surface surrounding an interior space;
b) said exterior surface having:
i) a LED or LCD display;
ii) an on/off switch for activating said display;
iii) an optional on/off switch for initiating data transmission;
iv) means for mounting said housing to an item of clothing; and
v) a data port for loading a conversion factor for converting voltage to dosage;
c) said interior space containing a plurality of layers stacked in the following order:
i) a mirrored surface coating;
ii) an LFS crystal scintillator;
iii) a transparent epoxy layer;
iv) a multipixel photon counter (MPPS) for providing an analog voltage in response to light emitted by said LFS crystal scintillator;
v) a printed circuit board electrically coupled to said MPPC and comprising:
(1) a temperature compensation circuit and a signal amplifier operably coupled to:
(2) an analog to digital converter for converting said analog voltage to a digital voltage operably coupled to:
(3) a microprocesser for converting said digital voltage to a daily dosage using a conversion factor operably coupled to:
(4) a memory for storing said daily dosage and a cumulative dosage operably coupled to:
(5) a wireless transmitter for transmitting said daily dosage and said cumulative dosage to a separate device.

24. A real-time radiation dosimeter, comprising a housing having a plurality of components therein that are operably connected together to measure radiation dosage, said components comprising:
a) a detector sandwich protected from stray light, said detector sandwich comprising a plurality of layers stacked in the following order:
i) a mirrored surface coating;
ii) a crystal scintillator having:
(1) a lower limit on noise-equivalent dose (NED) of 0.01 mrem-0.1 mrem;
(2) a detection capability of at least 5 keV-5 MeV;
(3) a continuous dose measurement range of 0.01 mrem/s-1 rem/s;
(4) an operating temperature of at least 25±10° C.; and
(5) an accuracy of ±5%;
iii) a multipixel photon counter (MPPS) for providing an analog voltage in response to light emitted by said LFS crystal scintillator;
b) means for on-board temperature compensation and dark matter compensation;
c) means for on-board calculation of daily dosage and cumulative dosage;
d) means for on-board displaying of said daily dosage and said cumulative dosage;
e) means for powering said dosimeter; and
f) means for wirelessly transmitting said daily dosage and said cumulative dosage to a remote system.

25. The dosimeter of claim 24, wherein said crystal scintillator is an LFS crystal scintillator.

26. A method of monitoring radiation dosage, said method comprising:
a) wearing the dosimeter of claim 1 during radiation procedures;
b) calculating a real-time dosage using said dosimeter;
c) storing said dosage in said memory;
d) repeating steps a to c on an ongoing basis;
e) wirelessly transmitting dosage information from said memory to a separate processor at intervals; and
f) storing said dosage information from step e in said separate processor.

27. The method of claim 26, further comprising reporting said dosage information to said display or to a third party or to a third-party processor.

28. The method of claim 26, further comprising reporting said dosage information to a warning system when said dosage approaches a predetermined danger limit.

29. A method of monitoring radiation dosage, said method comprising:
a) wearing the dosimeter of claim 24 during a daily radiation procedure;
b) calculating a daily dosage using said dosimeter;
c) storing said daily dosage and a cumulative dosage in said memory;
d) repeating steps a) to c) on additional days;
e) wirelessly transmitting said daily dosage and said cumulative dosage from said memory to a separate processor at intervals; and
f) storing said daily dosage and said cumulative dosage from step e) in said separate processor.
